(19) United States
(12) Patent Application Publication
(10) Pub. No.: US 2023/0265113 A1
(43) Pub. Date: Aug. 24, 2023

(54) PROCESS FOR PREPARING POLYSULFANE SILANES BY MEANS OF PHASE TRANSFER CATALYSIS

(71) Applicant: Evonik Operations GmbH, Essen (DE)

(72) Inventors: Julia HERMEKE, Gerlingen (DE); Katharina Marie PAULUS, Freiburg (DE); Sebastian ROSENSTINGL, Loerrach (DE); Helmut DROEGE, Bornheim (DE); Philipp ALBERT, Rheinfelden (DE); Alexander KOEPFER, Bernau im Schwarzwald (DE); Gert SMANS, Mortsel (BE); Kai Dieter BOLDT, Hanau (DE); Elisabeth BAUER, Kleines Wiesental (DE); Stefanie MAYER, Rheinfelden (DE); Horst MERTSCH, Rheinfelden (DE); Nicolas MARION, Saint-Louis (FR)

(73) Assignee: Evonik Operations GmbH, Essen (DE)

(21) Appl. No.: 18/043,708

(22) PCT Filed: Aug. 19, 2021
(86) PCT No.: PCT/EP2021/073015

§ 371 Date: Mar. 1, 2023

(30) Foreign Application Priority Data
Sep. 2, 2020 (DE) 10 2020 211 042.5

(51) Int. Cl. C07F 7/18; C08L 9/06

(52) U.S. Cl. CPC C07F 7/1892; C08L 9/06

(57) ABSTRACT

A process for preparing polysulfane silanes of formula (I):

(R¹)₃₋ₘR²ₘSi—R³—Sₓ—R³—SiR²ₘ(OR¹)₃₋ₘ (I),

may include reacting at least one halosilane of formula (II):

(R¹)₃₋ₘR²ₘSi—R³-Hal (II),

with M(SH)_{y} and/or M_{z}S and sulfur, in the presence of a phase transfer catalyst, a base and an aqueous phase, wherein the phase transfer catalyst is an alkylguanidinium catalyst of the formula (III):

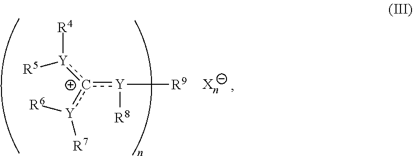

and at least two groups of R⁴, R⁵, R⁶, R⁷, and R⁸ are —(CH₂)₂CH₃, —CH₂CH₃, or —CH₃.

The invention relates to a process for preparing polysulfane silanes by means of phase transfer catalysis using an alkylguanidinium halide as catalyst.

U.S. Pat. Nos. 5,405,985, 5,583,245 and 5,663,396 disclose the preparation of compounds of the formula Z-Alk-Sn-Alk-Z by means of phase transfer catalysis.

U.S. Pat. No. 5,468,893 also discloses the preparation of polysulfane silanes by phase transfer catalysis in the presence of an alkali metal halide or alkali metal sulfate.

U.S. Pat. Nos. 6,384,255 and 6,448,426 disclose alteration of the sequence of addition in phase transfer catalysis.

In U.S. Pat. No. 6,384,256, M₂Sₙ or MSH is reacted with sulfur in a preliminary reaction in the presence of MOH.

U.S. Pat. Nos. 6,740,767 and 6,534,668 also disclose the addition of buffer in phase transfer catalysis.

EP 19217272.4 discloses the preparation of polysulfane silanes by means of phase transfer catalysis and subsequent purification of the crude product by carrier vapour distillation and/or ozone treatment during or after the reaction.

CN 108250233 A discloses the preparation of bis(triethoxysilylpropyl)tetrasulfane by means of catalyst with addition of potassium iodide. Hexabutylguanidinium chloride, inter alia, may be used as catalyst. The crude product is purified by filtration through activated carbon.

WO 2006/113122 discloses the preparation of thiocarboxylate silanes using phase transfer catalysis and use of an alkylguanidinium salt.

A disadvantage of the known PTC method for preparing polysulfane silanes is the presence of secondary constituents in the product, which may be on the one hand toxic degradation products of the catalyst or the catalyst itself. The former is the case, for example, when using tetrabutylammonium bromide (TBAB) as PTC catalyst, in which the tributylamine (TBA) formed as degradation product is classified as hazardous to health. If the catalyst itself dissolves in the product, the monomer content decreases on storage and is thereby linked to a worse effect in rubber mixtures. These by-products can be removed by further laborious purification steps such as filtration over activated carbon or distillation by carrier vapour distillation and/or ozone treatment.

The object of the present invention is to provide a simple PTC method for preparing polysulfane silanes in which the product is free from toxic secondary constituents and is storage-stable and the monomer content remains relatively constant without additional purification steps being necessary.

The invention relates to a process for preparing polysulfane silanes of the formula I

(R¹)₃₋ₘR²ₘSi—R³—Sₓ—R³—SiR²ₘ(OR¹)₃₋ₘ I

where R¹ are the same or different and are a C1-C10-alkoxy group, preferably ethoxy or methoxy, particularly preferably ethoxy, phenoxy group or alkyl polyether group —(R′—O)ᵣR″ where R′ is the same or different and is a branched or unbranched, saturated or unsaturated, aliphatic, aromatic or mixed aliphatic/aromatic divalent C1-C30 hydrocarbon group, preferably C₂H₄, r is an integer from 1 to 30, preferably 5, and R″ is unsubstituted or substituted, branched or unbranched, monovalent alkyl, alkenyl, aryl or aralkyl group, preferably C11-C15-alkyl group, R² are the same or different and are C6-C20 aryl groups, C1-C10 alkyl groups, C2-C20 alkenyl groups, C7-C20 aralkyl groups or halogen, R³ are the same or different and are a branched or unbranched, saturated or unsaturated, aliphatic, aromatic or mixed aliphatic/aromatic divalent C1-C30 hydrocarbon group, preferably (CH₂)₃, and m is the same or different and is 0, 1, 2 or 3, preferably 0, x is 2-10, preferably 2-4, by reacting at least one halosilane of the formula II

(R¹)₃₋ₘR²ₘSi—R³-Hal II

where Hal is Cl, Br or I, preferably Cl, with M(SH)_{y}, preferably NaSH, and/or M_{z}S, preferably Na₂S, and sulfur, where y=1 or 2, and M=Na or K when y=1, and M=Ca or Mg when y=2, and z=1 or 2, and M=Ca or Mg when z=1, and M=Na or K when z=2, in the presence of a phase transfer catalyst, a base and an aqueous phase, characterized in that the phase transfer catalyst is an alkylguanidinium catalyst of the formula III

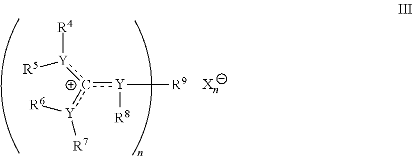

where Y is an element of main group 5, preferably N, P or As, particularly preferably N or P, especially preferably N, R⁴, R⁵, R⁸, R⁷ and R⁸ are identical or different —(CH₂)ₖCH₃ alkyl radicals, where k=0-9, or one or two ring closures —(CH₂)ₚ—, where p=1-5, is present between different substituents, R⁹ is an n-valent substituted, saturated or unsaturated, branched or unbranched hydrocarbon group and at least two, preferably at least four, groups of R⁴, R⁵, R⁸, R⁷ and R⁸ are —(CH₂)₂CH₃, —CH₂CH₃ or —CH₃, preferably —CH₂CH₃ or —CH₃, particularly preferably —CH₂CH₃, n is 1, 2, 3 or 4, preferably 1 or 2, particularly preferably 1, and X⁻ is F⁻, Cl⁻, I⁻, Br⁻, ClO₄⁻, PF₆⁻, BF₄⁻, (CeH₅)₄B⁻, H₂PO₄⁻, CH₃SO₃⁻, C₆H₅SO₃⁻, HSO₄⁻, NO₃⁻ or (SO₄²⁻)_{0.5}, preferably Cl⁻ or Br⁻, particularly preferably Cl⁻.

It may preferably be the case that R¹ is ethoxy, m=0 and R³═(CH₂)₃.

It may preferably be the case that Hal=Cl.

It may preferably be the case that Y is N.

It may preferably be the case that Y is N, n is 1 and at least two groups of R⁴, R⁵, R⁶, R⁷, R⁶ and R⁹ are —(CH₂)₂CH₃, —CH₂CH₃ or —CH₃.

It may be particularly preferably the case that Y is N, n is 1 and at least four groups of R⁴, R⁵, R⁶, R⁷, R⁶ and R⁹ are —CH₂CH₃ or —CH₃.

Polysulfane silanes of the formula I may be:
[(MeO)₃Si(CH₂)₃]₂S, [(MeO)₃Si(CH₂)₃]₂S₂, [(MeO)₃Si(CH₂)₃]₂S₃, [(MeO)₃Si(CH₂)₃]₂S₄, [(MeO)₃Si(CH₂)₃]₂S₅, [(MeO)₃Si(CH₂)₃]₂S₆, [(MeO)₃Si(CH₂)₃]₂S₇, [(MeO)₃Si(CH₂)₃]₂S₆, [(MeO)₃Si(CH₂)₃]₂S₉, [(MeO)₃Si(CH₂)₃]₂S₁₀, [(MeO)₃Si(CH₂)₃]₂S₁₁, [(MeO)₃Si(CH₂)₃]₂S₁₂,
[(EtO)₃Si(CH₂)₃]₂S, [(EtO)₃Si(CH₂)₃]₂S₂, [(EtO)₃Si(CH₂)₃]₂S₃, [(EtO)₃Si(CH₂)₃]₂S₄, [(EtO)₃Si(CH₂)₃]₂S₅, [(EtO)₃Si(CH₂)₃]₂S₆, [(EtO)₃Si(CH₂)₃]₂S₇, [(EtO)₃Si(CH₂)₃]₂S₆, [(EtO)₃Si(CH₂)₃]₂S₉, [(EtO)₃Si(CH₂)₃]₂S₁₀, [(EtO)₃Si(CH₂)₃]₂S₁₁, [(EtO)₃Si(CH₂)₃]₂S₁₂,
[(C₃H₇O)₃Si(CH₂)₃]₂S, [(C₃H₇O)₃Si(CH₂)₃]₂S₂, [(C₃H₇O)₃Si(CH₂)₃]₂S₃, [(C₃H₇O)₃Si(CH₂)₃]₂S₄, [(C₃H₇O)₃Si(CH₂)₃]₂S₅, [(C₃H₇O)₃Si(CH₂)₃]₂S₆, [(C₃H₇O)₃Si(CH₂)₃]₂S₇, [(C₃H₇O)₃Si(CH₂)₃]₂S₆, [(C₃H₇O)₃Si(CH₂)₃]₂S₉, [(C₃H₇O)₃Si(CH₂)₃]₂S₁₀, [(C₃H₇O)₃Si(CH₂)₃]₂S₁₁, [(C₃H₇O)₃Si(CH₂)₃]₂S₁₂.

The halosilanes of the formula (II) used may preferably be
3-chlorobutyl(triethoxysilane), 3-chlorobutyl(trimethoxysilane), 3-chlorobutyl(diethoxymethoxysilane), 3-chloropropyl(triethoxysilane), 3-chloropropyl(trimethoxysilane), 3-chloropropyl(diethoxymethoxysilane), 2-chloroethyl(triethoxysilane), 2-chloroethyl(trimethoxysilane), 2-chloroethyl(diethoxymethoxysilane), 1-chloromethyl(triethoxysilane), 1-chloromethyl(trimethoxysilane), 1-chloromethyl(diethoxymethoxysilane), 3-chloropropyl(diethoxymethylsilane), 3-chloropropyl(dimethoxymethylsilane), 2-chloroethyl(diethoxymethylsilane), 2-chloroethyl(dimethoxymethylsilane), 1-chloromethyl(diethoxymethylsilane), 1-chloromethyl(dimethoxymethylsilane), 3-chloropropyl(ethoxydimethylsilane), 3-chloropropyl(methoxydimethylsilane), 2-chloroethyl(ethoxydimethylsilane), 2-chloroethyl(methoxydimethylsilane), 1-chloromethyl(ethoxydimethylsilane), 1-chloromethyl(methoxydimethylsilane),
[(C₉H₁₉O—(CH₂—CH₂O)₂](MeO)₂Si(CH₂)₃Cl,
[(C₉H₁₉O—(CH₂—CH₂O)₃](MeO)₂Si(CH₂)₃Cl,
[(C₉H₁₉O—(CH₂—CH₂O)₄](MeO)₂Si(CH₂)₃Cl,
[(C₉H₁₉O—(CH₂—CH₂O)₅](MeO)₂Si(CH₂)₃Cl,
[(C₉H₁₉O—(CH₂—CH₂O)₆](MeO)₂Si(CH₂)₃Cl,
[(C₁₂H₂₅O—(CH₂—CH₂O)₂](MeO)₂Si(CH₂)₃Cl,
[(C₁₂H₂₅O—(CH₂—CH₂O)₃](MeO)₂Si(CH₂)₃Cl,
[(C₁₂H₂₅O—(CH₂—CH₂O)₄](MeO)₂Si(CH₂)₃Cl,
[(C₁₂H₂₅O—(CH₂—CH₂O)₅](MeO)₂Si(CH₂)₃Cl,
[(C₁₂H₂₅O—(CH₂—CH₂O)₆](MeO)₂Si(CH₂)₃Cl,
[(C₁₃H₂₇O—(CH₂—CH₂O)₂](MeO)₂Si(CH₂)₃Cl,
[(C₁₃H₂₇O—(CH₂—CH₂O)₃](MeO)₂Si(CH₂)₃Cl,
[(C₁₃H₂₇O—(CH₂—CH₂O)₄](MeO)₂Si(CH₂)₃Cl,
[(C₁₃H₂₇O—(CH₂—CH₂O)₅](MeO)₂Si(CH₂)₃Cl,
[(C₁₃H₂₇O—(CH₂—CH₂O)₆](MeO)₂Si(CH₂)₃Cl,
[(C₁₄H₂₉O—(CH₂—CH₂O)₂](MeO)₂Si(CH₂)₃Cl,
[(C₁₄H₂₉O—(CH₂—CH₂O)₃](MeO)₂Si(CH₂)₃Cl,
[(C₁₄H₂₉O—(CH₂—CH₂O)₄](MeO)₂Si(CH₂)₃Cl,
[(C₁₄H₂₉O—(CH₂—CH₂O)₅](MeO)₂Si(CH₂)₃Cl,
[(C₁₄H₂₉O—(CH₂—CH₂O)₆](MeO)₂Si(CH₂)₃Cl,
[(C₉H₁₉O—(CH₂—CH₂O)₂]₂(MeO)Si(CH₂)₃Cl,
[(C₉H₁₉O—(CH₂—CH₂O)₃]₂(MeO)Si(CH₂)₃Cl,
[(C₉H₁₉O—(CH₂—CH₂O)₄]₂(MeO)Si(CH₂)₃Cl,
[(C₉H₁₉O—(CH₂—CH₂O)₅]₂(MeO)Si(CH₂)₃Cl,
[(C₉H₁₉O—(CH₂—CH₂O)₆]₂(MeO)Si(CH₂)₃Cl,
[(C₁₂H₂₅O—(CH₂—CH₂O)₂]₂(MeO)Si(CH₂)₃Cl,
[(C₁₂H₂₅O—(CH₂—CH₂O)₃]₂(MeO)Si(CH₂)₃Cl,
[(C₁₂H₂₅O—(CH₂—CH₂O)₄]₂(MeO)Si(CH₂)₃Cl,
[(C₁₂H₂₅O—(CH₂—CH₂O)₅]₂(MeO)Si(CH₂)₃Cl,
[(C₁₂H₂₅O—(CH₂—CH₂O)₆]₂(MeO)Si(CH₂)₃Cl,
[(C₁₃H₂₇O—(CH₂—CH₂O)₂]₂(MeO)Si(CH₂)₃Cl,
[(C₁₃H₂₇O—(CH₂—CH₂O)₃]₂(MeO)Si(CH₂)₃Cl,
[(C₁₃H₂₇O—(CH₂—CH₂O)₄]₂(MeO)Si(CH₂)₃Cl,
[(C₁₃H₂₇O—(CH₂—CH₂O)₅]₂(MeO)Si(CH₂)₃Cl,
[(C₁₃H₂₇O—(CH₂—CH₂O)₆]₂(MeO)Si(CH₂)₃Cl,
[(C₁₄H₂₉O—(CH₂—CH₂O)₂]₂(MeO)Si(CH₂)₃Cl,
[(C₁₄H₂₉O—(CH₂—CH₂O)₃]₂(MeO)Si(CH₂)₃Cl,
[(C₁₄H₂₉O—(CH₂—CH₂O)₄]₂(MeO)Si(CH₂)₃Cl,
[(C₁₄H₂₉O—(CH₂—CH₂O)₅]₂(MeO)Si(CH₂)₃Cl,
[(C₁₄H₂₉O—(CH₂—CH₂O)₆]₂(MeO)Si(CH₂)₃Cl,
[(C₉H₁₉O—(CH₂—CH₂O)₂](EtO)₂Si(CH₂)₃Cl,
[(C₉H₁₉O—(CH₂—CH₂O)₃](EtO)₂Si(CH₂)₃Cl,
[(C₉H₁₉O—(CH₂—CH₂O)₄](EtO)₂Si(CH₂)₃Cl,
[(C₉H₁₉O—(CH₂—CH₂O)₅](EtO)₂Si(CH₂)₃Cl,
[(C₉H₁₉O—(CH₂—CH₂O)₆](EtO)₂Si(CH₂)₃Cl,
[(C₁₂H₂₅O—(CH₂—CH₂O)₂](EtO)₂Si(CH₂)₃Cl,
[(C₁₂H₂₅O—(CH₂—CH₂O)₃](EtO)₂Si(CH₂)₃Cl,
[(C₁₂H₂₅O—(CH₂—CH₂O)₄](EtO)₂Si(CH₂)₃Cl,
[(C₁₂H₂₅O—(CH₂—CH₂O)₅](EtO)₂Si(CH₂)₃Cl,
[(C₁₂H₂₅O—(CH₂—CH₂O)₆](EtO)₂Si(CH₂)₃Cl,
[(C₁₃H₂₇O—(CH₂—CH₂O)₂](EtO)₂Si(CH₂)₃Cl,
[(C₁₃H₂₇O—(CH₂—CH₂O)₃](EtO)₂Si(CH₂)₃Cl,
[(C₁₃H₂₇O—(CH₂—CH₂O)₄](EtO)₂Si(CH₂)₃Cl,
[(C₁₃H₂₇O—(CH₂—CH₂O)₅](EtO)₂Si(CH₂)₃Cl,
[(C₁₃H₂₇O—(CH₂—CH₂O)₆](EtO)₂Si(CH₂)₃Cl,
[(C₁₄H₂₉O—(CH₂—CH₂O)₂](EtO)₂Si(CH₂)₃Cl,
[(C₁₄H₂₉O—(CH₂—CH₂O)₃](EtO)₂Si(CH₂)₃Cl,
[(C₁₄H₂₉O—(CH₂—CH₂O)₄](EtO)₂Si(CH₂)₃Cl,
[(C₁₄H₂₉O—(CH₂—CH₂O)₅](EtO)₂Si(CH₂)₃Cl,
[(C₁₄H₂₉O—(CH₂—CH₂O)₆](EtO)₂Si(CH₂)₃Cl,
[(C₉H₁₉O—(CH₂—CH₂O)₂]₂(EtO)Si(CH₂)₃Cl,
[(C₉H₁₉O—(CH₂—CH₂O)₃]₂(EtO)Si(CH₂)₃Cl,
[(C₉H₁₉O—(CH₂—CH₂O)₄]₂(EtO)Si(CH₂)₃Cl,
[(C₉H₁₉O—(CH₂—CH₂O)₅]₂(EtO)Si(CH₂)₃Cl,
[(C₉H₁₉O—(CH₂—CH₂O)₆]₂(EtO)Si(CH₂)₃Cl,
[(C₁₂H₂₅O—(CH₂—CH₂O)₂]₂(EtO)Si(CH₂)₃Cl,
[(C₁₂H₂₅O—(CH₂—CH₂O)₃]₂(EtO)Si(CH₂)₃Cl,
[(C₁₂H₂₅O—(CH₂—CH₂O)₄]₂(EtO)Si(CH₂)₃Cl,
[(C₁₂H₂₅O—(CH₂—CH₂O)₅]₂(EtO)Si(CH₂)₃Cl,
[(C₁₂H₂₅O—(CH₂—CH₂O)₆]₂(EtO)Si(CH₂)₃Cl,
[(C₁₃H₂₇O—(CH₂—CH₂O)₂]₂(EtO)Si(CH₂)₃Cl,
[(C₁₃H₂₇O—(CH₂—CH₂O)₃]₂(EtO)Si(CH₂)₃Cl,
[(C₁₃H₂₇O—(CH₂—CH₂O)₄]₂(EtO)Si(CH₂)₃Cl,
[(C₁₃H₂₇O—(CH₂—CH₂O)₅]₂(EtO)Si(CH₂)₃Cl,
[(C₁₃H₂₇O—(CH₂—CH₂O)₆]₂(EtO)Si(CH₂)₃Cl,
[(C₁₄H₂₉O—(CH₂—CH₂O)₂]₂(EtO)Si(CH₂)₃Cl,
[(C₁₄H₂₉O—(CH₂—CH₂O)₃]₂(EtO)Si(CH₂)₃Cl,
[(C₁₄H₂₉O—(CH₂—CH₂O)₄]₂(EtO)Si(CH₂)₃Cl,
[(C₁₄H₂₉O—(CH₂—CH₂O)₅]₂(EtO)Si(CH₂)₃Cl,
[(C₁₄H₂₉O—(CH₂—CH₂O)₆]₂(EtO)Si(CH₂)₃Cl,
[(C₉H₁₉O—(CH₂—CH₂O)₂]₃Si(CH₂)₃Cl,
[(C₉H₁₉O—(CH₂—CH₂O)₃]₃Si(CH₂)₃Cl,
[(C₉H₁₉O—(CH₂—CH₂O)₄]₃Si(CH₂)₃Cl,
[(C₉H₁₉O—(CH₂—CH₂O)₅]₃Si(CH₂)₃Cl,
[(C₉H₁₉O—(CH₂—CH₂O)₆]₃Si(CH₂)₃Cl,
[(C₁₂H₂₅O—(CH₂—CH₂O)₂]₃Si(CH₂)₃Cl,
[(C₁₂H₂₅O—(CH₂—CH₂O)₃]₃Si(CH₂)₃Cl,
[(C₁₂H₂₅O—(CH₂—CH₂O)₄]₃Si(CH₂)₃Cl,
[(C₁₂H₂₅O—(CH₂—CH₂O)₅]₃Si(CH₂)₃Cl,
[(C₁₂H₂₅O—(CH₂—CH₂O)₆]₃Si(CH₂)₃Cl,
[(C₁₃H₂₇O—(CH₂—CH₂O)₂]₃Si(CH₂)₃Cl,
[(C₁₃H₂₇O—(CH₂—CH₂O)₃]₃Si(CH₂)₃Cl,
[(C₁₃H₂₇O—(CH₂—CH₂O)₄]₃Si(CH₂)₃Cl,
[(C₁₃H₂₇O—(CH₂—CH₂O)₅]₃Si(CH₂)₃Cl,
[(C₁₃H₂₇O—(CH₂—CH₂O)₆]₃Si(CH₂)₃Cl,
[(C₁₄H₂₉O—(CH₂—CH₂O)₂]₃Si(CH₂)₃Cl,
[(C₁₄H₂₉O—(CH₂—CH₂O)₃]₃Si(CH₂)₃Cl,
[(C₁₄H₂₉O—(CH₂—CH₂O)₄]₃Si(CH₂)₃Cl,
[(C₁₄H₂₉O—(CH₂—CH₂O)₅]₃Si(CH₂)₃Cl or
[(C₁₄H₂₉O—(CH₂—CH₂O)₆]₃Si(CH₂)₃Cl.

By way of preference, the alkylguanidinium catalyst of the formula III may be hexaethylguanidinium chloride, hexapropylguanidinium chloride, dimethyltetrabutylguanidinium chloride, tetramethyldibutylguanidinium chloride, diethyltetrabutylguanidinium chloride, tetrabutyldipropylguanidinium chloride, dibutyltetrapropylguanidinium chloride, diethyltetrapropylguanidinium chloride, tetraethyldipropylguanidinium chloride, tetraethyldibutylguanidinium chloride, tetraethyldipentylguanidinium chloride, tetramethyldipentylguanidinium chloride, dipentyltetrapropylguanidinium chloride, tetraethyldihexylguanidinium chloride, dihexyltetramethylguanidinium chloride, especially preferably hexaethylguanidinium chloride, tetraethyldihexylguanidinium chloride, tetraethyldipentylguanidinium chloride or dibutyltetraethylguanidinium chloride.

The base used may be M_{3-w} CO₃, M(OH)_{W}, M_{3-w} (HPO₄), M(H₂PO₄)_{W}, M₃(PO₄)_{W}, where w is 1 or 2, and M═Na or K when w=1, and M=Ca or Mg when w=2. The base used may preferably be Na₂CO₃ or NaOH.

The process according to the invention for preparing polysulfane silanes of the formula I can be carried out at temperatures of 25° C. to 200° C., preferably 60° C. to 110° C.

In the process according to the invention for preparing polysulfane silanes of the formula I, the phase transfer catalyst of the formula III and then the halosilane of the formula II may be added to the aqueous phase, prepared by M(SH)_{y}, preferably NaSH, a base, preferably NaOH or Na₂CO₃, preferably in aqueous solution, and sulfur.

The molar ratio between the halosilane of the formula II used and the M(SH)_{y} used may be between 1.0:0.35 and 1.0:1.0, preferably between 1.0:0.45 and 1.0:0.55.

The molar ratio between the halosilane of the formula II used and the base may be between 1.0:0.35 and 1.0:1.0, preferably between 1.0:0.45 and 1.0:0.60.

The molar ratio between the halosilane of the formula II used and sulfur may be between 1.0:0.4 and 1.0:3.0, preferably between 1.0:0.5 and 1.0:1.5.

The molar ratio between the halosilane of the formula II used and the phase transfer catalyst of the formula III may be between 1.0:0.0005 and 1.0:0.05, preferably between 1.0:0.0005 and 1.0:0.005.

The process according to the invention for preparation of polysulfane silanes of the formula I can be carried out without organic solvent. The aqueous phase used may contain process salts from the preceding batch. During the preparation of the aqueous phase, the amount of the phase transfer catalyst of the formula III may be added in part or in full. The M(SH)_{y} and/or M_{z}S and/or M_{g}Sₓ, g=1 or 2, M=Na or K when g=2 and M=Ca or Mg when g=1, used for preparing polysulfane silanes of the formula I may be prepared before or during the reaction.

In the reaction, the aqueous phase may be mixed with the silane of the formula II. It is possible here either to meter the aqueous phase into the halosilane of the formula II or to meter the halosilane of the formula II into the aqueous phase. The halosilane of the formula II is preferably metered into the aqueous phase.

During the reaction, the halosilane of the formula II may be added in portions or continuously, preferably continuously.

The process according to the invention may be carried out in a reaction vessel closed or open to the atmosphere.

The contents of the reaction vessel may be mixed. Suitable means of mixing the contents of the reaction vessel are by external circulations or agitation of the contents of the reaction vessel by means of gases or stirrer systems, preferably stirrer systems.

The process can be carried out continuously or batchwise.

After the reaction, the aqueous phase can be separated from the organic phase. The salt formed as by-product can be removed by filtration. Volatile secondary constituents can be removed by thin-film evaporation.

An advantage of the process according to the invention is the avoidance of toxic secondary constituents in the product and impurities in the product due to the catalyst and the improved storage stability of the product linked thereto.

Analytical gas chromatography (GC) of reaction mixtures and pure substances was carried out with an Agilent 7820A gas chromatograph. The chromatograms were evaluated in accordance with ASTM D 6843-10 with the following additions: determination of tributylamine (recorded in addition to the calibration and calculation of results).

Analytical separations of the sulfur compounds and the determination of the sulfur chain length were carried out using an analytical HPLC Series 1260 Infinity II system from Agilent Technologies according to ASTM D 6844-10.

Column: Bakerbond C18 (RP), 5 μm, 4.6×250 mm, flow rate 1.50 ml/min, A=254 nm, column temperature 30° C., mobile phase: mixture of 200 ml of tetrabutylammonium bromide solution (prepared from 400 mg of tetrabutylammonium bromide in 1 I of demineralized water), 450 ml of ethanol and 1350 ml of methanol. The average sulfur chain length and the S2 to S10 sample constituents were determined in an analysis and evaluation described in ASTM D 6844.

A C18 column was used for LC-MS measurements (mobile phase: A: 5 mmol ammonium acetate in water, B: 1-propanol+acetonitrile (1:1 vol %), gradient). The target substance was externally calibrated and measured in SIM mode.

### EXAMPLES

### Comparative Example 1: Bis(Triethoxysilylpropyl)Tetrasulfane Using Tetra-n-Butylammonium Bromide (from EP 19217272.4 Comparative Example 2)

For preparation of bis(triethoxysilylpropyl)tetrasulfane by means of phase transfer catalysis, a mixture of sodium hydroxide (81 g, 1.0 mol, 1.0 equiv.), sodium hydrogensulfide (284 g, 2.0 mol, 2.0 equiv., 40.0% aqueous solution) and water (158 g, 8.8 mol, 4.2 equiv.) was heated to 70° C. The reaction mixture was first stirred at 70° C. for 10 min, then sulfur (184 g, 5.7 mol, 2.8 equiv.) was added to the mixture, which was stirred at 72° C. for a further 15 minutes. Tetra-n-butylammonium bromide (17 g, 0.03 mol, 0.01 equiv., 50% aqueous solution) and (3-chloropropyl)triethoxysilane (999 g, 4.2 mol, 2.0 equiv.) were added successively to the reaction mixture at 70-80° C. The suspension was stirred at 75° C. for 2 hours (GC conversion after 2 hours=98%). After the reaction had ended, water (249 g) was added and the phases were separated at 71° C. The crude product (1.1 kg) was obtained as a yellow liquid. Low boilers were then removed by means of a thin-film evaporator at 140° C. and 10 mbar abs., such that the bis(triethoxysilylpropyl)tetrasulfane was isolated as bottom product and then filtered.

LC-MS: 50 ppm TBAB (PTC catalyst)

GC: 0.38% tributylamine (degradation product of the PTC catalyst)

HPLC: monomer content 93.8%

Storage stability: HPLC monomer content (3 months): 92.9%

### Comparative Example 2: Bis(Triethoxysilylpropyl)Disulfane Using Tetra-n-Butylammonium Bromide (from EP 19217272.4 Comparative Example 1)

For preparation of bis(triethoxysilylpropyl)disulfane by means of phase transfer catalysis, a mixture of sodium carbonate (189 g, 1.8 mol, 1.2 equiv.), sodium hydrogensulfide (225 g, 1.6 mol, 1.0 equiv., 40.0% aqueous solution) and water (572 g, 32 mol, 21 equiv.) was heated to 72° C. The reaction mixture was first stirred at 72° C. for 10 min, then sulfur (55 g, 1.7 mol, 1.1 equiv.) was added to the mixture, which was stirred at 72° C. for a further 45 minutes. Tetra-n-butylammonium bromide (20 g, 0.03 mol, 0.02 equiv., 50% aqueous solution) and (3-chloropropyl)triethoxysilane (743 g, 3.1 mol, 2.0 equiv.) were added successively to the reaction mixture at 70-80° C. The suspension was stirred at 75° C. for 3 hours (GC conversion after 1 hour=98%). After the reaction had ended, water (589 g) was added and the phases were separated at 71° C. The crude product (793 g) was obtained as a yellow liquid. Low boilers were then removed by means of a thin-film evaporator at 140° C. and 10 mbar abs., such that the bis(triethoxysilylpropyl)disulfane was isolated as bottom product and then filtered.

LC-MS: 4 ppm TBAB (PTC catalyst)

GC: 0.54% tributylamine (degradation product of the PTC catalyst)

HPLC: monomer content 91.5%

Storage stability: HPLC monomer content (3 months): 90.7%

### Comparative Example 3: Bis(Triethoxysilylpropyl)Disulfane Using Hexabutylguanidinium Chloride

For preparation of bis(triethoxysilylpropyl)disulfane by means of phase transfer catalysis, a mixture of sodium carbonate (94 g, 0.9 mol, 1.2 equiv.), sodium hydrogensulfide (107.9 g, 0.77 mol, 1.0 equiv., 40.0% aqueous solution) and water (286 g, 15.9 mol, 20.6 equiv.) was heated to 75° C. The reaction mixture was first stirred at 75° C. for 10 min, then sulfur (27.8 g, 0.9 mol, 1.1 equiv.) was added to the mixture, which was stirred at 75° C. for a further 45 minutes. Hexabutylguanidinium chloride (2.8 g, 0.003 mol, 0.004 equiv., 50% aqueous solution) and (3-chloropropyl)triethoxysilane (372 g, 1.5 mol, 2.0 equiv.) were added successively to the reaction mixture at 70-80° C. The suspension was stirred at 75° C. for 3 hours. After the reaction had ended, water (426 g) was added and the phases were separated at 71° C. The crude product (355.32 g) was obtained as a yellow liquid. Low boilers were then removed by means of a thin-film evaporator at 140° C. and 10 mbar abs., such that the bis(triethoxysilylpropyl)disulfane was isolated as bottom product and then filtered.

LC-MS: 0.2% HBG-Cl (PTC catalyst)

GC: 0.00% tributylamine

HPLC: monomer content 89.4%

Storage stability: HPLC monomer content (3 months): 86.8%

### Comparative Example 4: Bis(Triethoxysilylpropyl)Tetrasulfane Using Hexabutylguanidinium Chloride

For preparation of bis(triethoxysilylpropyl)tetrasulfane by means of phase transfer catalysis, a mixture of sodium hydroxide (21 g, 0.5 mol, 1.0 equiv.), sodium hydrogensulfide (71 g, 0.5 mol, 1.0 equiv., 40.0% aqueous solution) and water (40 g, 2.2 mol, 4.2 equiv.) was heated to 70° C. The reaction mixture was first stirred at 70° C. for 10 min, then sulfur (184 g, 5.7 mol, 2.8 equiv.) was added to the mixture, which was stirred at 72° C. for a further 15 minutes. Hexabutylguanidinium chloride (1.1 g, 0.001 mol, 0.003 equiv., 50% aqueous solution) and (3-chloropropyl)triethoxysilane (250 g, 1.0 mol, 2.0 equiv.) were added successively to the reaction mixture at 70-80° C. The suspension was stirred at 75° C. for 2 hours (GC conversion after 2 hours=98%). After the reaction had ended, water (98 g) was added and the phases were separated at 71° C. The crude product (277.91 g) was obtained as an orange to brown liquid. Low boilers were then removed by means of a thin-film evaporator at 140° C. and 10 mbar abs., such that the bis(triethoxysilylpropyl)tetrasulfane was isolated as bottom product and then filtered.

LC-MS: 0.2% HBG-Cl (PTC catalyst)

GC: 0.00% tributylamine

monomer content 88.1%

Storage stability: HPLC monomer content (3 months): 82.8%

### Example 1: Bis(Triethoxysilylpropyl)Disulfane Using Tetraethyldibutylguanidinium Chloride

For preparation of bis(triethoxysilylpropyl)disulfane by means of phase transfer catalysis, a mixture of sodium carbonate (94 g, 0.89 mol, 1.15 equiv.), sodium hydrogensulfide (107.9 g, 0.77 mol, 1.0 equiv., 40.0% aqueous solution) and water (286 g, 15.9 mol, 20.6 equiv.) was heated to 75° C. The reaction mixture was first stirred at 75° C. for 10 min, then sulfur (27.7 g, 0.9 mol, 1.12 equiv.) was added to the mixture, which was stirred at 75° C. for a further 45 minutes.

Tetraethyldibutylguanidinium chloride (4.1 g, 0.006 mol, 0.008 equiv., 50% aqueous solution) and (3-chloropropyl)triethoxysilane (372 g, 1.5 mol, 2.0 equiv.) were added successively to the reaction mixture at 70-80° C. The suspension was stirred at 75° C. for 3 hours. After the reaction had ended, water (450.00 g) was added and the phases were separated at 71° C. The crude product (361.16 g) was obtained as a colourless to pale green liquid. Low boilers were then removed by means of a thin-film evaporator at 140° C. and 10 mbar abs., such that the bis(triethoxysilylpropyl)disulfane was isolated as bottom product and then filtered.

GC-MS analysis did not show any presence of catalyst degradation products (diethylamine, dibutylamine) in the product.

6 ppm TEDBG-Cl (PTC catalyst)

GC: 0.00% tributylamine

HPLC: monomer content) 94.7%

Storage stability: HPLC monomer content (3 months): 94.4%

### Example 2: Bis(Triethoxysilylpropyl)Tetrasulfane Using Tetraethyldibutylguanidinium Chloride

For preparation of bis(triethoxysilylpropyl)tetrasulfane by means of phase transfer catalysis, a mixture of sodium hydroxide (41 g, 1.0 mol, 1.0 equiv.), sodium hydrogensulfide (143 g, 1.01 mol, 0.98 equiv., 40.1% aqueous solution) and water (78 g, 4.4 mol, 4.24 equiv.) was heated to 70° C., then sulfur (94 g, 2.1 mol, 2.82 equiv.) was added to the mixture which was stirred at 70° C. for a further 15 minutes. Tetraethyldibutylguanidinium chloride (3.32 g, 0.005 mol, 0.005 equiv., 50% aqueous solution) and (3-chloropropyl)triethoxysilane (501 g, 2.1 mol, 2.0 equiv.) were added successively to the reaction mixture at 72° C.-78° C. The suspension was stirred at 75° C. for 3 hours. After the reaction had ended, water (122.00 g) was added and the phases were separated at 70° C.

The crude product (559.68 g) was obtained as a dark brown liquid. Low boilers were then removed by means of a thin-film evaporator at 140° C. and 10 mbar abs., such that the bis(triethoxysilylpropyl)tetrasulfane was isolated as bottom product and then filtered.

GC-MS analysis did not show any presence of catalyst degradation products (diethylamine, dibutylamine) in the product.

LC-MS: 190 ppm TEDBG-Cl (PTC catalyst)

GC: 0.00% tributylamine

HPLC: monomer content 95.1%

Storage stability: HPLC monomer content (3 months): 93.9%

### Example 3: Bis(Triethoxysilylpropyl)Tetrasulfane Using Hexaethylguanidinium Chloride

For preparation of bis(triethoxysilylpropyl)tetrasulfane by means of phase transfer catalysis, a mixture of sodium hydroxide (0.730 g, 18.2 mol, 1.0 equiv.), sodium hydrogensulfide (1.003 kg, 17.9 mol, 0.980 equiv., 40.1% aqueous solution) and water (1.394 kg, 77.4 mol, 4.24 equiv.) was heated to 106° C., then sulfur (1.653 kg, 51.6 mol, 2.825 equiv.) was added to the mixture which was stirred at 106° C. for a further 15 minutes. Hexaethylguanidinium chloride (39 g, 0.1 mol, 0.008 equiv., 35% aqueous solution) and (3-chloropropyl)triethoxysilane (8.789 kg, 36.5 mol, 2.0 equiv.) were added successively to the reaction mixture at 106° C.-112° C. The suspension was stirred at 106° C. for 3 hours (GC conversion after 2 hours=98%). After the reaction had ended, water (2.559 kg) was added and the phases were separated at 80° C. The crude product (10.076 kg) was obtained as a yellow liquid. Low boilers were then removed by means of a thin-film evaporator at 140° C. and 10 mbar abs., such that the bis(triethoxysilylpropyl)tetrasulfane was isolated as bottom product and then filtered.

GC-MS analysis did not show any presence of catalyst degradation products (diethylamine) in the product.

LC-MS: 30 ppm HEG-Cl

GC: 0.00% tributylamine

HPLC: monomer content 92.7%

Storage stability: HPLC monomer content (3 months): 91.6%

Table 1 shows all values of comparative examples 1-4 and examples 1-3. Comparative example 1 and 2 using TBAB as catalyst show tributylamine (TBA) in the end product. TBA is classified as hazardous to health. The products prepared using the process according to the invention (examples 1-3) show no tributylamine (TBA) in the end product.

Comparison of comparative example 3 with example 1 (preparation of bis(triethoxysilylpropyl)disulfane) reveals better storage stability (smaller alteration in the monomer content) for the inventive example.

Comparison of comparative example 4 with example 2 and 3 (both preparation of bis(triethoxysilylpropyl)tetrasulfane) reveals better storage stability (smaller alteration in the monomer content) for the inventive examples.

TABLE 1

| | | | | | |
|---|---|---|---|---|---|
| | | Monomer | Monomer | TBA content | |
| | | content | content | in the | Catalyst content |
| Product | Catalyst | 0 months | 3 months | product | in the product |

Comparative examples

| | | | | | | |
|---|---|---|---|---|---|---|
| 1 | Bis(triethoxysilyl- | TBAB | 93.8 | 92.9 | 0.38% | 50 ppm TBAB |
| | propyl)tetrasulfane | | | | | |
| 2 | Bis(triethoxysilyl- | TBAB | 91.5 | 90.7 | 0.54% | 4 ppm TBAB |
| | propyl)disulfane | | | | | |
| 3 | Bis(triethoxysilyl- | HBG-Cl | 89.4 | 86.8 | 0.00% | 0.2% HBG-Cl |
| | propyl)disulfane | | | | | |
| 4 | Bis(triethoxysilyl- | HBG-Cl | 88.1 | 82.8 | 0.00% | 0.2% HBG-Cl |
| | propyl)tetrasulfane | | | | | |

Examples

| | | | | | | |
|---|---|---|---|---|---|---|
| 1 | Bis(triethoxysilyl- | TEDBG-Cl | 94.7 | 94.4 | 0.00% | 6 ppm TEDBG-Cl |
| | propyl)disulfane | | | | | |
| 2 | Bis(triethoxysilyl- | TEDBG-Cl | 95.1 | 93.9 | 0.00% | 190 ppm TEDBG-Cl |
| | propyl)tetrasulfane | | | | | |
| 3 | Bis(triethoxysilyl- | HEG-Cl | 92.7 | 91.6 | 0.00% | 30 ppm HEG-Cl |
| | propyl)tetrasulfane | | | | | |

### Example 4: Examination of Rubber Characteristics

The materials used are listed in Table 2. Test methods used for the mixtures and vulcanizates thereof were effected according to Table 3. The rubber mixtures were produced with a GK 1.5E internal mixer from Harburg Freudenberger Maschinenbau GmbH.

TABLE 2
List of materials used in the examples

| | |
|---|---|
| S-SBR | BUNA ® VSL 4526-2, Ultrapolymers Deutschland GmbH |
| BR | BUNA ® CB 24, Ultrapolymers Deutschland GmbH |
| Silica | ULTRASIL ® 7000 GR, Evonik Industries AG |
| Carbon black | CORAX ® N330, Gustav Grolmann GmbH & Co. KG |
| Silane prepared using HBG-Cl | |
| catalyst (comparative example 4 | |
| after 3 months' storage) | |
| Silane with HEG-Cl catalyst | |
| (example 3 after 3 months' | |
| storage) | |
| ZnO | Zinkweiss Rotsiegel, Grillo Zinkoxid GmbH |
| Stearic acid | Edenor ST1, Caldic Deutschland GmbH |
| Oil | Vivatec 500, Hansen & Rosenthal KG |
| Wax | Protektor G 3108, Paramelt B. V. |
| 6PPD | Vulkanox ® 4020/LG, Rhein-Chemie GmbH |
| TMQ | Vulkanox ® HS/LG, Rhein-Chemie GmbH |
| DPG | Rhenogran ® DPG-80, Rhein-Chemie GmbH |
| CBS | Vulkacit ® CZ/EG-C, Rhein-Chemie GmbH |
| Sulfur | ground sulfur, Azelis S. A. |
| TBzTD | Richon TBzTD OP, Weber & Schaer GmbH & Co. KG |

TABLE 3
List of physical test methods used in example 4

| Method | Standard |
|---|---|
| Determination of viscosity, ML | DIN 53523/3, ISO 289-1 |
| (1 + 4) (ME) | |
| Vulcameter testing, moving die | DIN 53529/3, ISO 6502 |
| method Time to conversion t90% (min) | |
| Tensile strain on ring 1 specimens | DIN 53 504, ISO 37 |
| at 23° C. | |
| Tensile strength (MPa) | |
| Shore A hardness | DIN 53505/ISO 7619-1 |
| Abrasion test (mm³) | DIN ISO 4649 ASTM D5963 |
| Tear resistance, DIE C (N/mm) | ASTM D 624 |
| Tear resistance, Graves (N/mm) | DIN ISO 34-1 |
| Tear resistance, DIN (N/mm) | DIN ISO 34-1, ISO 34-1 |

The mixture formulation is listed in Table 4.

TABLE 4
Mixture formulation of the S-SBR/BR mixture

| | Mixture 1 | |
|---|---|---|
| Substance | (comparative example) | Mixture 2 |
| 1st Stage | | |
| S-SBR | 96.3 | 96.3 |
| BR | 30 | 30 |
| Silica | 80 | 80 |
| Silane from comparative example | 6.4 | — |
| 4 after 3 months' storage | | |
| Silane from example 3 after 3 | — | 6.4 |
| months' storage | | |
| Carbon black | 5.0 | 5.0 |
| ZnO | 2.0 | 2.0 |
| Stearic acid | 2.0 | 2.0 |
| Oil | 8.75 | 8.75 |
| Wax | 2.0 | 2.0 |
| 6PPD | 2.0 | 2.0 |
| TMQ | 1.5 | 1.5 |
| 2nd Stage | | |
| 1st stage batch | | |
| DPG | 2.5 | 2.5 |
| 3rd Stage | | |
| 2nd stage batch | | |
| CBS | 1.6 | 1.6 |
| Sulfur | 2.0 | 2.0 |
| TBzTD | 0.2 | 0.2 |

The mixture preparation is described in Table 5.

TABLE 5
Mixture production of the S-SBR/BR mixture

| 1st Stage | GK 1.5 E, feed temp. 60° C., 70 rpm, filling factor 0.61 |
|---|---|
| | Batch temp.: 145-165° C. |
| 0.0-0.15′ | Polymers, TMQ, 6PPD |
| 0.15-1.15′ | 1/2 silica, silane |
| 1.15-1.15′ | Vent, purge |
| 1.15-2.15′ | a) premix carbon black and oil and add together |
| | b) 1/2 silica |
| | c) remaining constituents from the first stage |
| 2.15-2.15′ | Vent, purge |
| 2.15-3.45′ | ZnO and stearic acid |
| | Mix at 140-160° C., optionally varying speed |
| | Eject |
| | About 45 sec, on the roll (4 mm gap), eject sheet |
| Storage: 24 h/RT | |
| 2nd Stage | GK, 1.5 E, feed temp. 75° C., 75 rpm, filling factor 0.59 |
| | Batch temp.: 145-165° C. |
| 0.0-1.0′ | 1st stage batch |
| 1.0-3.0′ | DPG, mix at 145-155° C., optionally varying speed |
| 3.0-3.0′ | Eject |
| | About 45 sec, on the roll (4 mm gap), eject sheet |
| Storage: 4-24 h/RT | |
| 3rd Stage | GK, 1.5 E, feed temp. 50° C., 55 rpm, filling factor 0.57 |
| | Batch temp.: 90-110° C. |
| 0.0-2.0′ | 2nd stage batch, accelerator, sulfur |
| 2.0-2.0′ | Eject and process on the roll for about 20 sec, with gap 3-4 mm |
| Storage: 12 h/RT | |

The results of physical tests on the rubber mixtures specified here and vulcanizates thereof are listed in Table 6. The vulcanizates were produced from the untreated mixtures from the third stage by heating at 165° C. for 20 min under 130 bar. Mixture 2 with the silane prepared by the process according to the invention shows improved tear resistance.

TABLE 6
Results of physical tests on the rubber
mixtures and their vulcanizates

| | Mixture 1 | |
|---|---|---|
| Method | (comparative example) | Mixture 2 |
| Untreated mixture | | |
| ML (1 + 4) at 100° C. 3rd stage | 55 | 53 |
| MDR: 165° C.; 0.5° t 90% | 6.1 | 6.0 |
| Vulcanizate | | |
| Tensile strength at 23° C./MPa | 13.4 | 15.0 |
| Shore A hardness/SH | 61 | 62 |
| DIN abrasion/mm³ | 71 | 72 |
| Tear resistance, DIE C/(N/mm) | 35.2 | 41.0 |
| Tear resistance, Graves (N/mm) | 34.7 | 40.2 |
| Tear resistance DIN (N/mm) | 17.1 | 18.0 |

1. A process for preparing one or more polysulfane silanes formula (I)
(R¹)₃₋ₘR²ₘSi—R³—Sₓ—R³—SiR²ₘ(OR¹)₃₋ₘ (I)
the process comprising:
reacting at least one halosilane of formula (II):
(R¹)₃₋ₘR²ₘSi—R³-Hal (II),
with M(SH)_{y} and/or M_{z}S and sulfur, in the presence of a phase transfer catalyst, a base, and an aqueous phase,
wherein
R¹ are independently a C₁-C₁₀-alkoxy group, phenoxy group, or (R′—O)ᵣR″ where R′ is independently a branched or unbranched, saturated or unsaturated, aliphatic, aromatic or mixed aliphatic/aromatic divalent C₁-C₃₀ hydrocarbon group, r is an integer in a range of from 1 to 30, and R″ is unsubstituted or substituted, branched or unbranched, monovalent alkyl, alkenyl, aryl, or aralkyl group,
R² are independently C₆-C₂₀ aryl, C₁-C₁₀ alkyl, C₂-C₂₀ alkenyl, C₇-C₂₀ aralkyl, or halogen,
R³ are independently a branched or unbranched, saturated or unsaturated, aliphatic, aromatic or mixed aliphatic/aromatic divalent C₁-C₃₀ hydrocarbon group,
m is the same or different and are 0, 1, 2 or 3, x is 2-10,
Hal is Cl, Br, or I
y is 1 or 2, and M is Na or K when y is 1, and M is Ca or Mg when y is 2,
z is 1 or 2, and M is Ca or Mg when z is 1, and M is Na or K when z is 2, and
wherein the phase transfer catalyst is an alkylguanidinium catalyst of formula (III) 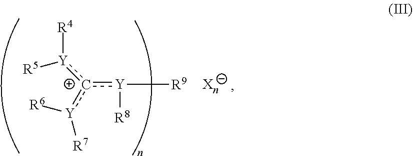
wherein
Y is an element of main group 5,
R⁴, R⁵, R⁶, R⁷, and R⁸ are independently —(CH₂)ₖCH₃ alkyl radicals, where k is in a range of from 0 to 9, or one or two ring closures —(CH₂)ₚ—, where p is in a range of from 1 to 5, is present between different substituents,
R⁹ is an n-valent substituted, saturated or unsaturated, branched or unbranched hydrocarbon group, and
at least two groups of R⁴, R⁵, R⁶, R⁷, and R⁸ are —(CH₂)₂CH₃, —CH₂CH₃, or —CH₃,
n is 1, 2, 3, or 4, and
X⁻ is Cl⁻, F⁻, I⁻, Br⁻, ClO₄⁻, PF₆⁻, BF₄⁻, (C₆H₅)₄B⁻, H₂PO₄⁻, CH₃SO₃⁻, C₆H₅SO₃⁻, HSO₄⁻, NO₃⁻, or (SO₄²⁻)_{1/2}.

2. The process of claim 1, wherein
R¹ is ethoxy,
m is 0,
R³ is (CH₂)₃,
M is Na, and Hal
Hal is Cl.

3. The process of claim 1, wherein Y is N.

4. The process of claim 1, wherein
n is 1, and
at least two groups of R⁴, R⁵, R⁶, R⁷, R⁸ and R⁹ are —(CH₂)₂CH₃, —CH₂CH₃, or —CH₃.

5. The process of claim 4, wherein at least four groups of R⁴, R⁵, R⁶, R⁷, R⁸ and R⁹ are —CH₂CH₃ or —CH₃.

6. The process of claim 4, wherein the alkylguanidinium catalyst of the formula (III) is hexaethylguanidinium chloride, hexapropylguanidinium chloride, dimethyltetrabutylguanidinium chloride, tetramethyldibutylguanidinium chloride, diethyltetrabutylguanidinium chloride, tetrabutyldipropylguanidinium chloride, dibutyltetrapropylguanidinium chloride, diethyltetrapropylguanidinium chloride, tetraethyldipropylguanidinium chloride, tetraethyldibutylguanidinium chloride, tetraethyldipentylguanidinium chloride, tetramethyldipentylguanidinium chloride, dipentyltetrapropylguanidinium chloride tetraethyldihexylguanidinium chloride, or dihexyltetramethylguanidinium chloride.

7. The process of claim 5, wherein the alkylguanidinium catalyst of the formula (III) is hexaethylguanidinium chloride, tetraethyldihexylguanidinium chloride, tetraethyldipentylguanidinium chloride, or dibutyltetraethylguanidinium chloride.

8. The process of claim 1, wherein the base is M_{3-w}CO₃, M(OH)_{w}, M_{3-w}(HPO₄), M(H₂PO₄)_{w}, or M₃(PO₄)_{w},
wherein
w is 1 or 2, and M is Na or K when w is 1, and M is Ca or Mg when w is 2.

9. The process of claim 8, wherein the base is Na₂CO₃.

10. The process of claim 1, wherein the reacting is conducted at a temperature in a range of from 60° C. to 110° C.

11. The process of claim 4, wherein the alkylguanidinium catalyst of the formula (III) is hexaethylguanidinium chloride, hexapropylguanidinium chloride, dimethyltetrabutylguanidinium chloride, tetramethyldibutylguanidinium chloride, diethyltetrabutylguanidinium chloride, tetrabutyldipropylguanidinium chloride, dibutyltetrapropylguanidinium chloride, diethyltetrapropylguanidinium chloride, tetraethyldipropylguanidinium chloride, tetraethyldibutylguanidinium chloride, tetraethyldipentylguanidinium chloride, tetramethyldipentylguanidinium chloride, dipentyltetrapropylguanidinium chloride tetraethyldihexylguanidinium chloride, or dihexyltetramethylguanidinium chloride, and
wherein the base is M_{3-w}CO₃, M(OH)_{w}, M_{3-w}(HPO₄), M(H₂PO₄)_{w}, or M₃(PO₄)_{w}, W being 1 or 2, with M being Na or K when w is 1, and M being Ca or Mg when w is 2.

12. The process of claim 5, wherein the alkylguanidinium catalyst comprises hexaethylguanidinium chloride.

13. The process of claim 5, wherein the alkylguanidinium catalyst comprises tetraethyldihexylguanidinium chloride.

14. The process of claim 5, wherein the alkylguanidinium catalyst comprises tetraethyldipentylguanidinium chloride.

15. The process of claim 5, wherein the alkylguanidinium catalyst comprises dibutyltetraethylguanidinium chloride.

16. The process of claim 8, wherein the base is NaOH.

17. The process of claim 2, wherein the base is Na₂CO₃ or NaOH.

18. The process of claim 6, wherein the base is Na₂CO₃ or NaOH.
